(19) United States
(12) Patent Application Publication
(10) Pub. No.: US 2016/0351141 A1
(43) Pub. Date: Dec. 1, 2016

(54) TOUCH DISPLAY DEVICE AND DRIVING METHOD THEREOF

(71) Applicant: HON HAI PRECISION INDUSTRY CO., LTD., New Taipei (TW)

(72) Inventor: FENG-HSIANG LIU, Tu-Cheng (TW)

(21) Appl. No.: 14/820,220

(22) Filed: Aug. 6, 2015

(30) Foreign Application Priority Data
May 29, 2015 (TW) 104117352

(51) Int. Cl. G09G 3/36; G06F 3/044; G06F 3/041

(52) U.S. Cl. CPC G09G 3/3648; G06F 3/0412; G06F 3/044; G06F 3/0416; G09G 2300/0426; G09G 2300/0439; G09G 2300/0478

(57) ABSTRACT

A touch display device is provided. The touch display device includes: a touch display panel and a driver circuit system. The touch display includes a first substrate and a drive layer arranged on the first substrate. The drive layer includes at least two gate lines and at least two source lines intersected with the gate lines. The touch display panel is divided into at least two blocks, each block including at least two gate lines and at least two drive circles, each drive circle including a display scanning period. The driving circuit system includes a gate driver coupled with the at least two gate lines, the gate driver being configured to scan the gate lines from an initial scanning line to a last scanning line in sequence during each display scanning period. For at least one block, initial scanning lines of at least two display scanning periods are different.

### FIELD

The subject matter herein generally relates to a touch display device and a driving method for a touch display device.

### BACKGROUND

Generally, a touch display device can include a display panel, a touch panel and related control circuits. A conventional driving method for a touch display device can divide scanning lines into a plurality of blocks. For each block, display scanning and touch scanning can be done sequentially during a scanning circle. During each touch scanning process, the display scanning can be interrupted, thus, continuity of display may be reduced.

### BRIEF DESCRIPTION OF THE DRAWINGS

Implementations of the present technology will now be described, by way of example only, with reference to the attached figures.

FIG. 1 is an isometric view of an exemplary embodiment of a touch display panel, the touch display panel including a first substrate.

FIG. 2 is a cross sectional view taking along line II-II of the touch display panel in FIG. 1.

FIG. 3 is a diagrammatic view of an exemplary embodiment of a driving layer of the first substrate in FIG. 1.

FIG. 4 is a diagrammatic view of an exemplary embodiment of a relationship between the driving layer and common electrodes.

FIG. 5 is a block diagram of an exemplary embodiment of an in-cell touch display device including a touch display panel.

FIG. 6 is a diagrammatic view of an exemplary embodiment of a configuration of blocks of a touch display panel.

FIG. 7 is a diagrammatic view of an exemplary embodiment of sequential waveforms in different scanning circles caused by gate driver scanning gate lines of a block S1 in FIG. 6.

FIG. 8 is a diagrammatic view of another exemplary embodiment of sequential waveforms in different scanning circles caused by gate driver scanning gate lines of a block S1 in FIG. 6.

FIG. 9 is a diagrammatic view of another exemplary embodiment of sequential waveforms during an exemplary frame.

FIG. 10 is a diagrammatic view of another exemplary embodiment of sequential waveforms during a second exemplary frame.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

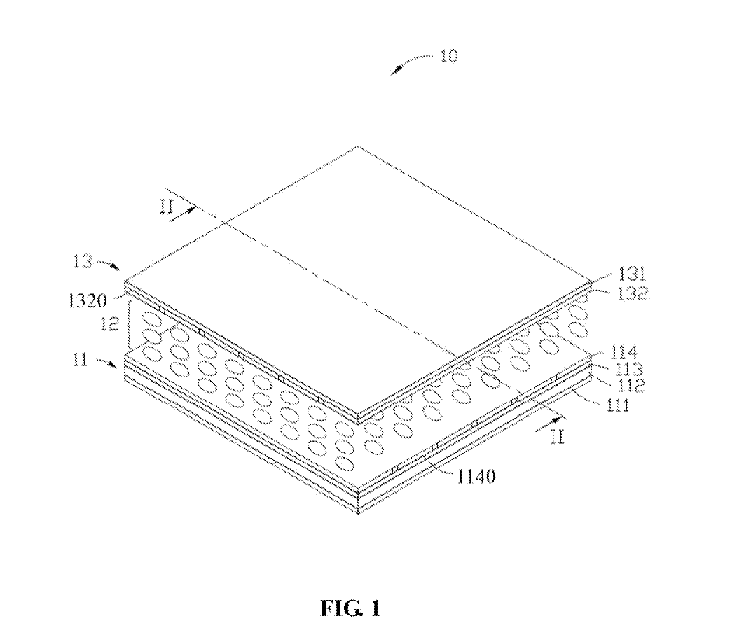

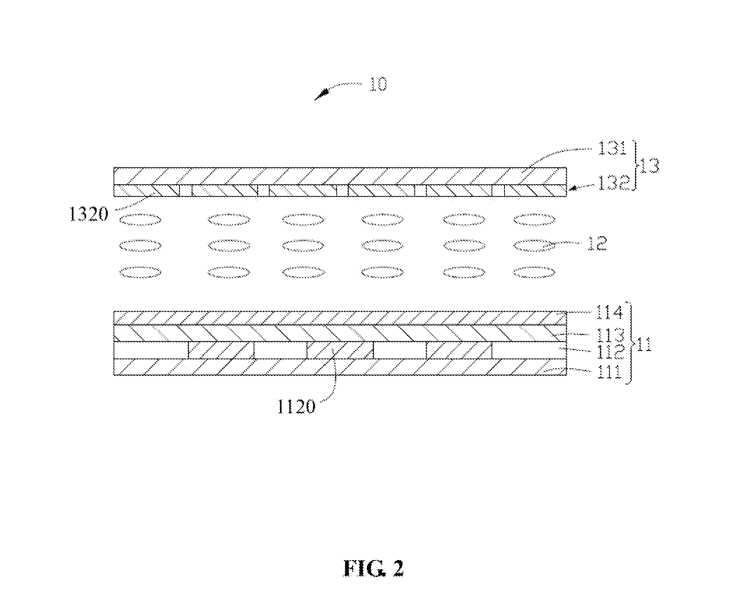

Referring to FIGS. 1 and 2, an exemplary embodiment of a touch display panel 10 is illustrated. In the exemplary embodiment, the touch display panel 10 can be configured to display images instantaneously in time sequence and sensing touch operations on the touch display panel 10. In the exemplary embodiment, the touch display panel 10 can be an in-cell touch display panel. In at least one exemplary embodiment, the touch display panel 10 can be any currently available touch display panel.

The touch display panel 10 can include a first substrate 11, a second substrate opposite to the first substrate 11, and a liquid crystal layer 12 arranged between the first substrate 11 and the second substrate 13. The first substrate 11 can be an array substrate and can be named as to a lower substrate. The first substrate 11 can include a first substrate base 111, a driving layer 112, an insulating layer 113, and a common electrode layer 114. The driving layer 112 can be arranged on the first substrate base 111 and covered by the insulating layer 113. The driving layer 112 can include a plurality of pixel electrodes 1120 arranged in a substantially rectangle configuration. The common electrode layer 114 is arranged on the insulating layer 113 and can include a plurality of common electrodes 1140. A horizontal electric field can be generated between the plurality of pixel electrodes 1120 and the plurality of common electrodes 1140, which can drive liquid crystal molecules of the liquid crystal layer 12 to deflect so as to cause the touch display device to display images.

The second substrate 13 can be named as an upper substrate or a color film substrate. The second substrate 13 can include a second substrate base 131 and a touch sensitive electrode layer 132. The touch sensitive electrode layer 132 can include a plurality of touch sensitive electrodes 1320 arranged at regular interval along a first direction. The touch sensitive electrodes 1320 can be configured to detect touch operations on the touch display panel 10. The touch sensitive electrodes 1320 can be configured to operate with the common electrodes 1140 to identify positions where the touch operations are applied.

In the exemplary embodiment, the first substrate base 111 and the second substrate base 131 can be made of transparent glass or plastics. The pixel electrodes 1120, the common electrodes 1140, and the touch sensitive electrodes 1320 can be made of Indium Tin Oxide (ITO) or Indium Zinc Oxide (IZO). In at least one exemplary embodiment, the first substrate base 111 and the second substrate base 131 can be made of any suitable materials. The pixel electrodes 1120, the common electrodes 1140, and the touch sensitive electrodes 1320 can be made of any suitable materials.

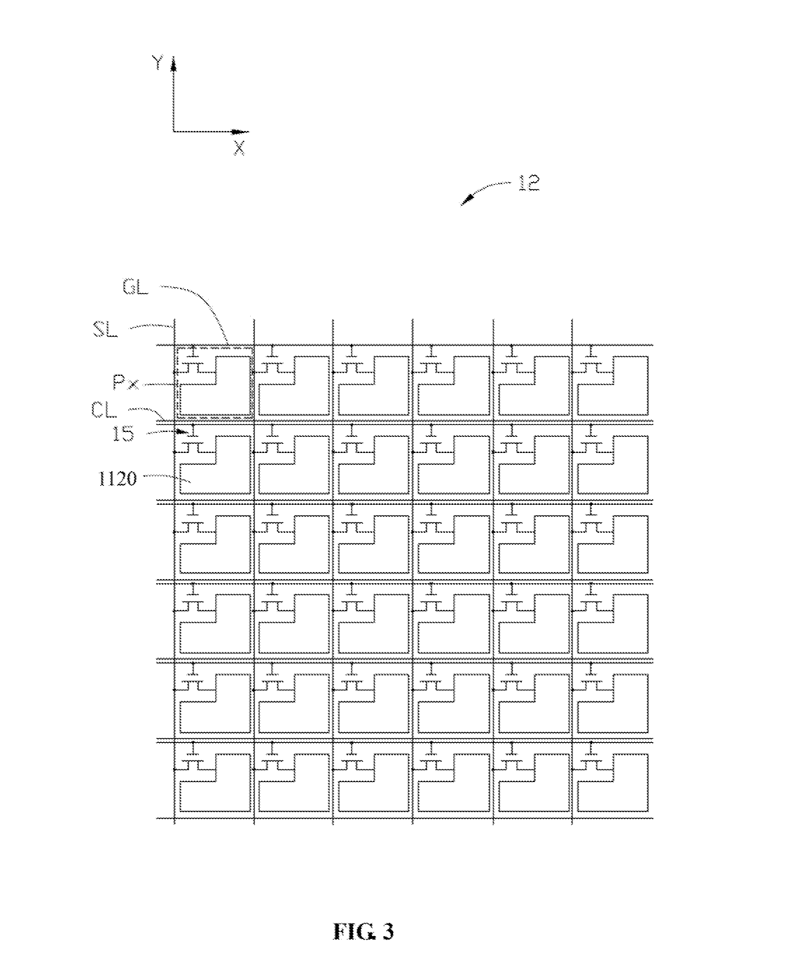

Referring to FIG. 3, a diagrammatic view of an exemplary embodiment of the driving layer 112 is illustrated. The driving layer 112 can include a plurality of gate lines (GLs) parallel to each other, a plurality of source lines (SLs) which are perpendicularly and insulatively intersect the GLs, and a plurality of common electrode lines (CLs) which are insulated from the GLs and CLs and are parallel to the GLs. The GLs can be named as scanning lines and the SLs can be named as data lines. The GLs, CLs and the SLs intersect with each other to define a plurality of pixel units Pxs which are arranged in a rectangle configuration. Each pixel unit Px can include a Thin Film Transistor (TFT) 15 and a pixel electrode 1120 coupled with the TFT 15. The GLs and the CLs extend along a first direction (For example, along X axis), while the SLs extends along the second direction (for example, along Y axis) different from the first direction.

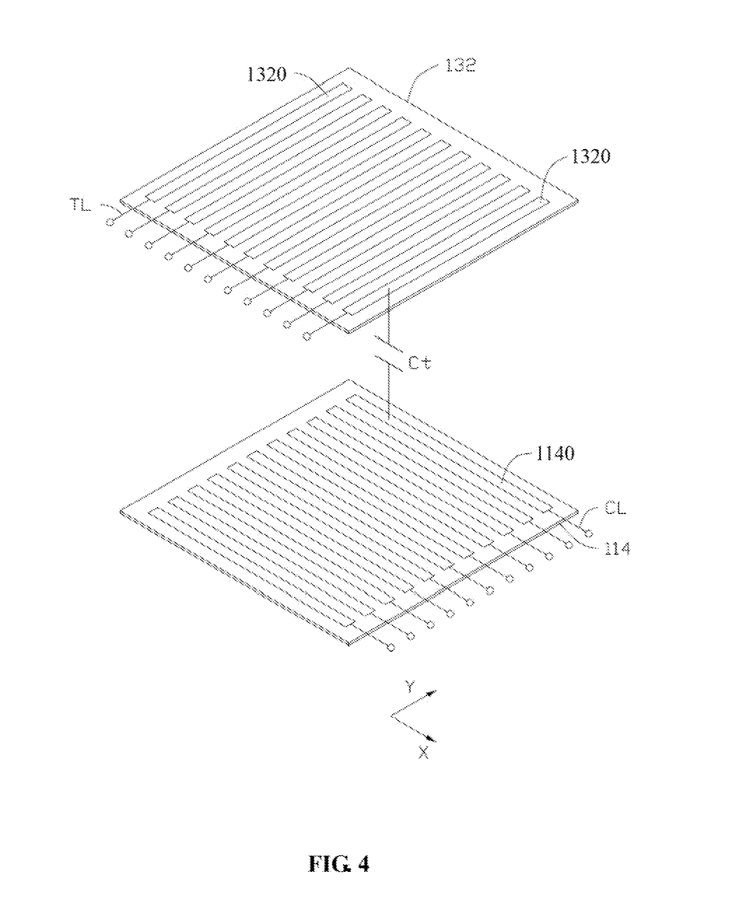

Referring to FIGS. 3 and 4, the plurality of common electrodes 1140 can be spaced arranged along the second direction and can be insulated from each other. Each common electrode 1140 can be coupled with one of the common electrode lines CLs and can be in a substantially rectangle shape. Each common electrode 1140 can be corresponding to a row of pixel units Pxs. That is, the number of the common electrodes 1140 can equal to the number of rows of the pixel units Pxs. Orthographic projection of each common electrode at a plane where the plurality of pixel units Pxs is located can overlap a corresponding row of pixel units Pxs. In at least one exemplary embodiment, the common electrode 1140 can be in any other suitable shape, for example, parallelogram, ellipse.

The plurality of touch sensitive electrodes 1320 can be spaced arranged along the first direction and can be insulated from each other. The plurality of touch sensitive electrodes 1320 can be intersected insulatively with the plurality of common electrodes 1140. In the exemplary embodiment, the touch sensitive electrodes 1320 can be in a substantially rectangle shape. When the touch sensitive electrodes 1320 and the common electrodes 1140 are powered, sensing capacitance Ct is generated between the touch sensitive electrodes 1320 and the common electrodes 1140 to detect touch operations on the touch display panel 10. Alternatively, the touch sensitive electrodes 1320 can be substituted for some signal lines arranged at the first substrate 11, for example, extra sensing electrodes arranged on the first substrate 11.

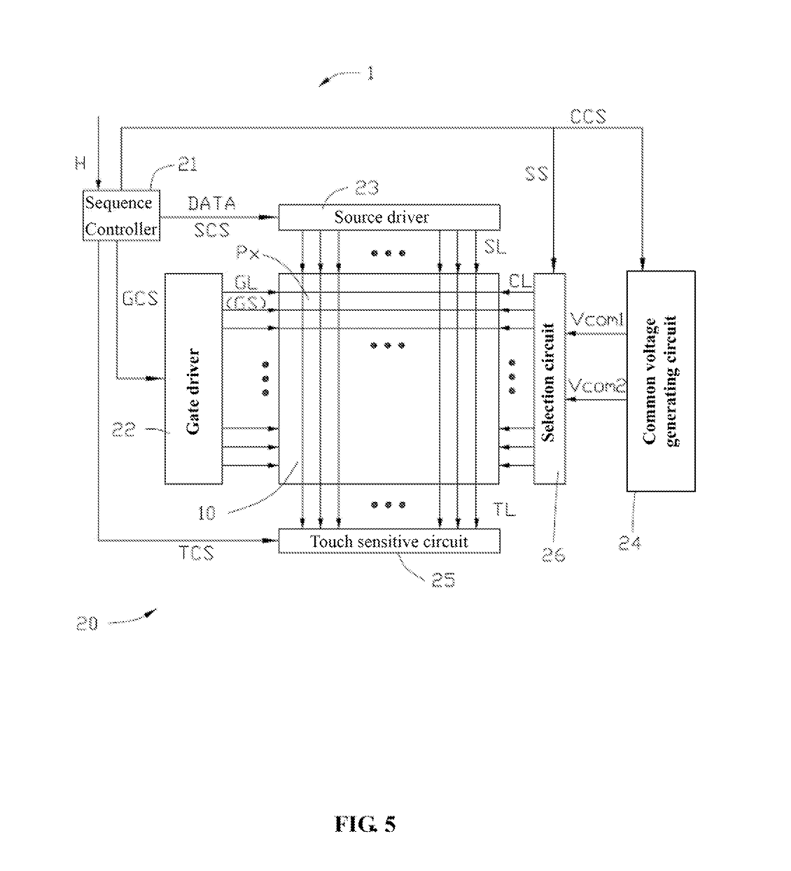

Referring to FIG. 5, a block diagram of an exemplary embodiment of an in-cell touch display device 1 is illustrated. The in-cell touch display device 1 can include the touch display panel 10 and a driving circuit system 20. In detail, the driving circuit system 20 can be configured to drive the touch display panel 10 to display images and to detect touch operations on the touch display panel 10. In the exemplary embodiment, the driving circuit system 20 can include a sequence controller 21, a gate driver 22, a source driver 23, a common voltage generating circuit 24, a touch sensitive circuit 25, and a selection circuit 26. It should be noted that the name of all the elements shown and described above are used for illustrative purpose only and cannot be limitations to the embodiments. In at least one embodiment, the gate driver 22 and the source driver 23 can be substituted for a display driver (or a display driving chip or a display driving circuit).

The sequence controller 21 can be configured to receive horizontal synchronizing signals H from an outside system, output gate control signals GCS to the gate driver 22, output source control signals SCS and image data DATA to the source driver 23, output common voltage control signals CCS to the common voltage generating circuit 24, and output selection signals SS to the selection circuit 26. The sequence controller 21 further can be configured to output touch control signals TCS to the touch sensitive circuit 25.

The gate driver 22 can be coupled to the pixel unit Px through the GLs, and can transmit gate signals GS (also named as scanning signals) to the pixel unit Px through the GLs in response to the gate control signals GCS so as to selectively enable corresponding pixel units PXs. The source driver 23 can be coupled to the pixel unit Px through the SLs, and can transmit the image data DATA to the pixel unit Px through the SLs so as to cause the pixel unit Pxs to display images.

The common voltage generating circuit 24 can be configured to generate common voltages with at least two different waveforms. In the exemplary embodiment, the common voltages with at least two different waveforms can include a first common voltage Vcom1 and a second common voltage Vcom2. The first common voltage Vcom1 can be a direct voltage (DC) with a first constant voltage. The second common voltage Vcom2 can be an alternating voltage (AC) with a voltage varying between a second constant voltage and a third constant voltage. The second common voltage Vcom2 can be served as touch control signals applied to the common electrodes 1140. In the exemplary embodiment, the second constant voltage can be 0V, while the third constant voltage can be 3.5V. In at least one embodiment, the second constant voltage and the third constant voltage can be any other suitable values.

The selection circuit 26 can be coupled to the common voltage generating circuit 24 and be coupled to the common electrodes 1140 through the CLs. The selection circuit 26 can be configured to receive the first common voltage Vcom1 and the second common voltage Vcom2 and to transmit the first common voltage Vcom1 and the second common voltage Vcom2 to corresponding common electrodes 1140 in response to the selection signals SS.

The touch sensitive circuit 25 can be coupled to the touch sensitive electrodes 1320 through touch sensitive lines TLs and to receive touch signals TS in response to the touch control signals TCS. The touch sensitive circuit 25 can be configured to process and analyze the touch signals TS so as to identify a position where a touch operation applied on the touch display panel 10.

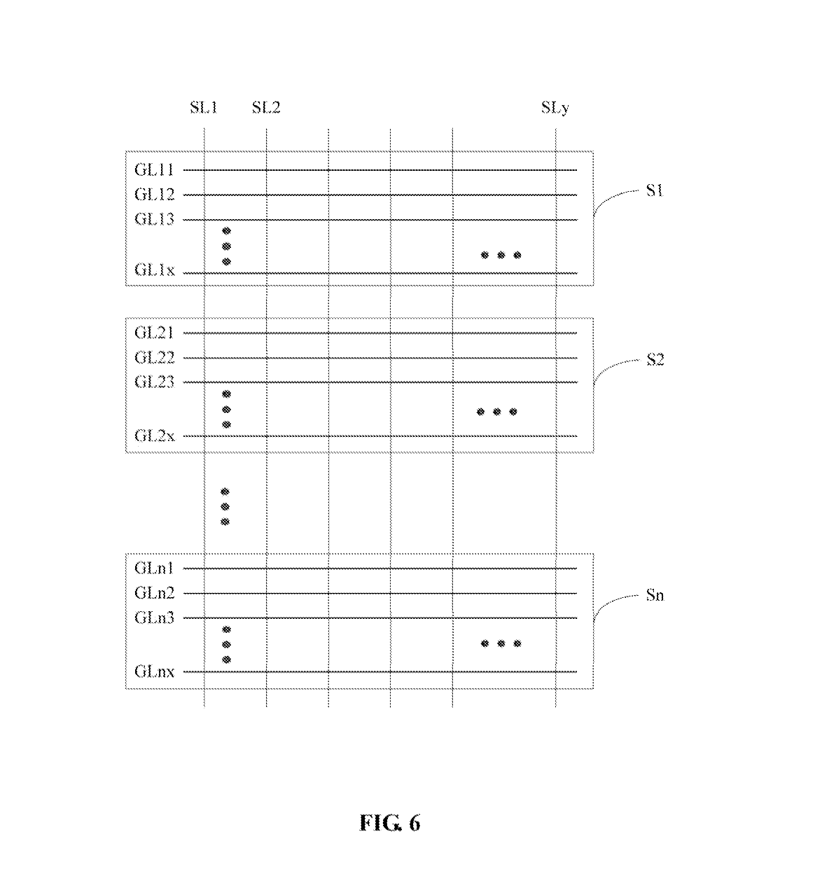

Referring to FIG. 6, a diagrammatic view of an exemplary embodiment of a configuration of blocks of a touch display panel is illustrated. In the exemplary embodiment, the touch display panel 10 can include n blocks, for example, S1, S2 . . . Sn, n>=2. At least one of the n blocks can include two or more GLs. In the exemplary embodiment, all the blocks can include same number of GLs.

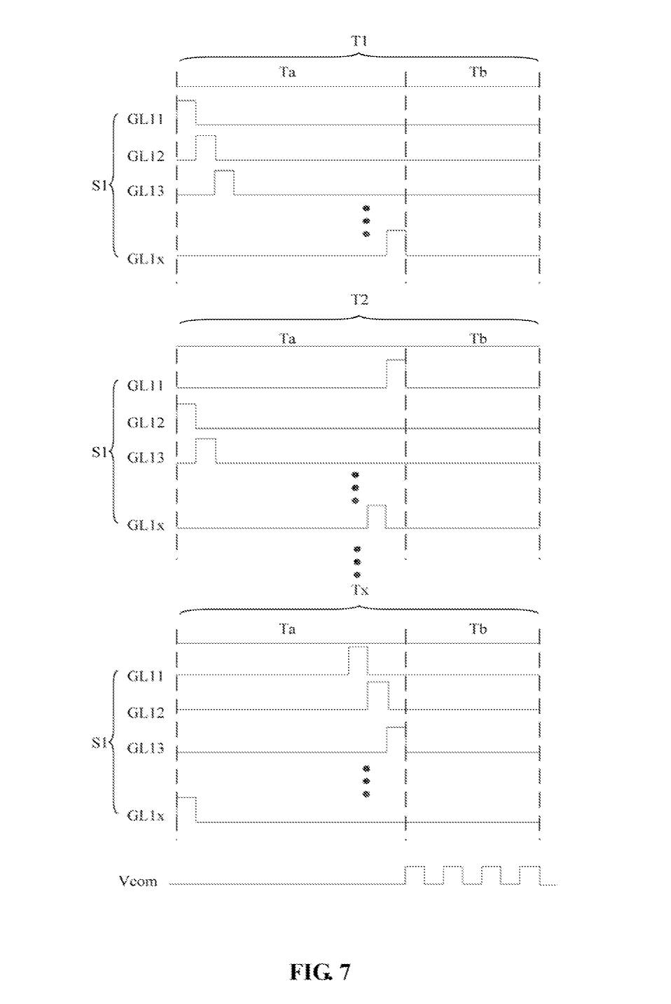

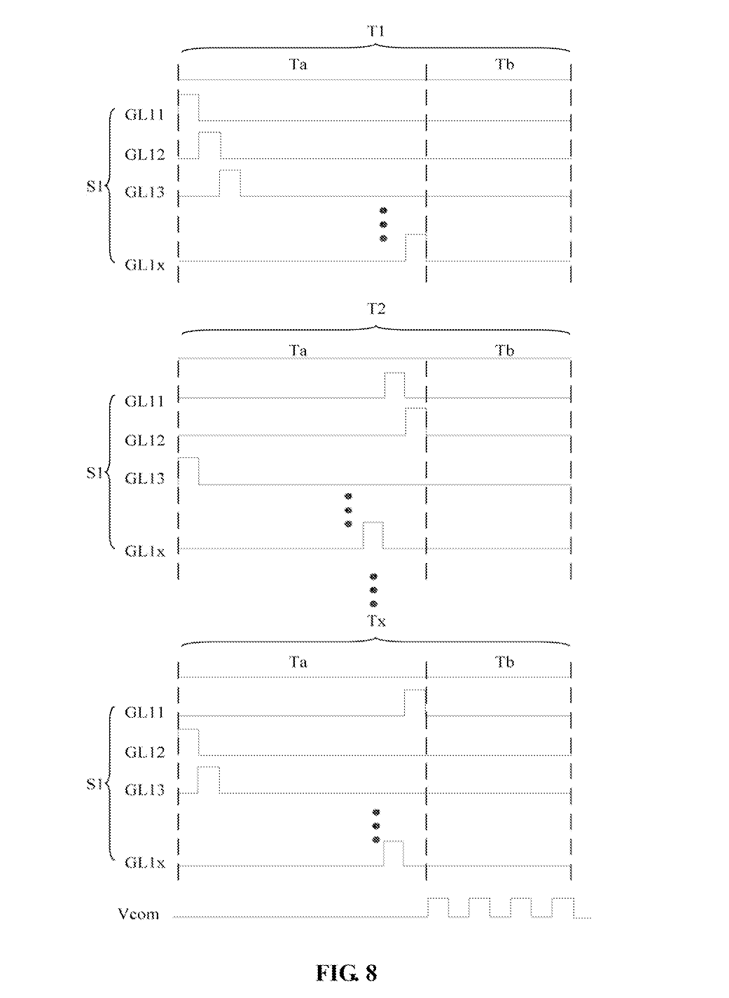

Referring to FIG. 7 and FIG. 8, the gate driver 22 can transmit the gate control signals GCS to the GLs in sequence so as to drive the touch display panel 10 to display images. Each drive circle of the touch display panel 10 can include a display scanning period Ta and a touch scanning period Tb. During the display scanning period Ta, the gate driver 22 scans the GLs in each block so as to drive the touch display panel 10 to display images. During the touch scanning period Tb, the touch sensitive circuit 25 scans corresponding touch sensitive electrodes 132 so as to detect touch operations on the touch display panel 10.

During each display scanning period Ta, the common electrodes 1140 can be applied a constant voltage. While, during each touch scanning period Tb, the common electrodes 1140 can be applied alternating voltages (the touch control signals), thus the touch sensitive circuit 25 can detect touch operations by detecting voltage variation of the touch sensitive electrodes 1320.

For each block, the gate driver 22 can scan the gate lines from an initial scanning line to a last scanning line in sequence during a display scanning period. In the exemplary embodiment, for a selected block including at least two gate lines, the gate driver 22 can select different gate line as an initial scanning line in different drive circles. Alternatively or additionally, for a selected block, the initial scanning lines of two successive display scanning periods can be different from each other.

In the exemplary embodiment, for a selected block, the gate driver 22 can select one of the GLs as the initial scanning line according to the arrangement of the GLs in sequence in different display scanning period. For example, for a selected block S1, there are a plurality of gate lines GL11, GL12, . . . GL1x arranged in sequence. The gate driver 22 can select the first gate line GL11 as the initial scanning line in the first display scanning period T1, select the second gate line GL12 as the initial scanning line in the second display scanning period T2, . . . and select the x gate line GL1x as the initial scanning line in the x display scanting period Tx. In a scanning period successive to the Tx, the gate driver 22 can select the first gate line GL11 as the initial scanning line again.

In at least one exemplary embodiment, the initial scanning line can be selected in a reverse order. For example, for the selected block S1, the gate driver 22 can select the last gate line GL1x as the initial scanning line in the first display scanning period Tx, and select the first gate line GL1x as the initial scanning line in the first display scanting period T1. In a scanning period successive to the Tx, the gate driver 22 can select the last gate line GL1x as the initial scanning line again.

In at least one exemplary embodiment, for a selected block, the gate driver 22 can select one of the gate lines as the initial scanning line in a random order. Additionally, the initial scanning lines of two successive display scanning periods can be different from each other. Referring to FIG. 8, the gate driver 22 can select the first gate line GL11 as the initial scanning line in the first display scanning period T1, select the third gate line GL13 as the initial scanning line in the second display scanning period T2, and select the second gate line GL12 as the initial scanning line in the x display scanning period Tx.

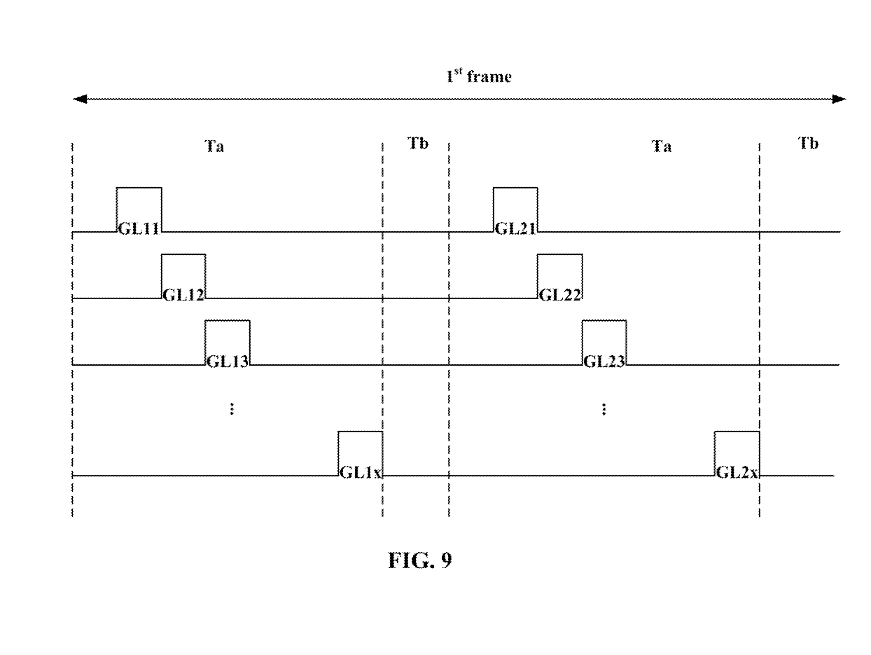

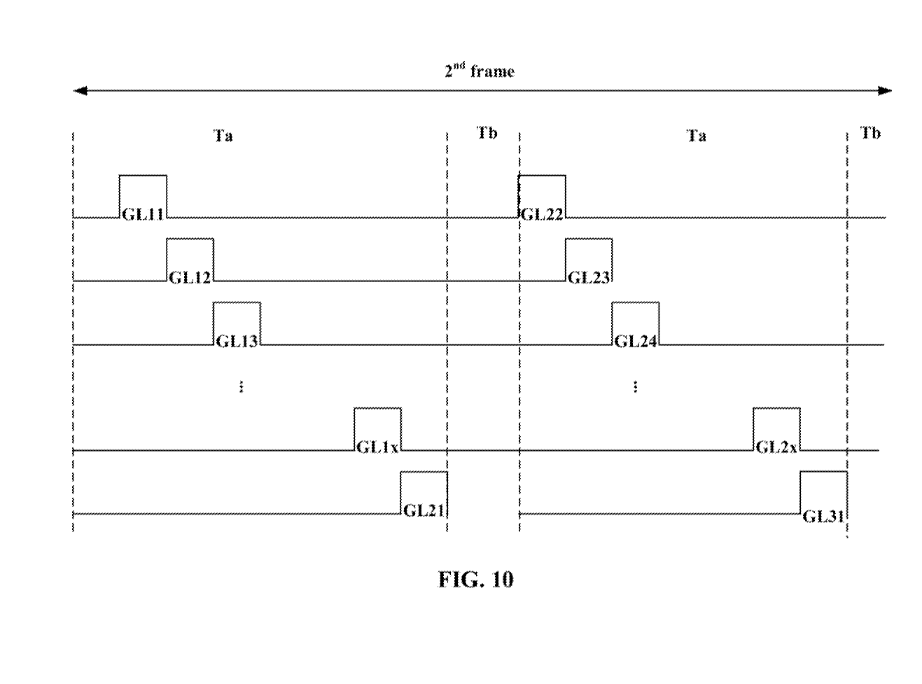

In at least one exemplary embodiment, the gate driver 22 can scan the gate lines sequentially during a display scanning period. The display scanning period can be interrupted and then a touch scanning period begins. The display scanning period can be interrupted at any predefined gate line so that the initial scanning line of the successive display scanning period can be different. Referring to FIG. 9 and FIG. 10, for the 1^{st} frame, the display scanning period can be interrupted at the x^{th} gate line, for example, GL1x, GL2x, GL3x, . . . GLnx. For the 2^{nd} frame, the display scanning period is interrupted at the first gate line, for example, GL11, G21, . . . , GLn1.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A touch display device comprising:
a touch display panel, wherein the touch display panel includes a first substrate and a drive layer arranged on the first substrate;
the drive layer including at least two gate lines and at least two source lines intersected with the at least two gate lines;
the touch display panel is divided into at least two blocks, each block including at least two gate lines and at least two drive circles, each drive circle including a display scanning period and a touch scanning period; and
a driving circuit system including a gate driver coupled with the at least two gate lines, the gate driver being configured to scan the gate lines from an initial scanning line to a last scanning line in sequence during each display scanning period; for at least one block, initial scanning lines of at least two display scanning periods are different.

2. The touch display device according to claim 1, wherein for each block the initial scanning lines of at least two display scanning periods are different.

3. The touch display device according to claim 1, wherein for at least one block the initial scanning lines of any two successive display scanning periods are different.

4. The touch display device according to claim 1, wherein for each block initial scanning lines of any two successive display scanning periods are different.

5. The touch display device according to claim 1, wherein each block includes the same number of gate lines.

6. The touch display device according to claim 1, wherein for one of the at least two blocks, each gate line of the one of the at least two blocks is selected as the initial scanning line in an order that is same with the order the gate lines are arranged.

7. The touch display device according to claim 1, wherein for one of the at least two blocks, each gate line of the one of the at least two blocks is selected as the initial scanning line in an order that is contrary to the order the gate lines are arranged.

8. The touch display device according to claim 1, wherein for one of the at least two blocks, each gate line of the one of the at least two blocks is selected as the initial scanning line in a random order.

9. The touch display device according to claim 1, wherein the initial scanning line in display scanning period of different frame is different.

10. The touch display device according to claim 1, further comprising a second substrate opposite to the first substrate, wherein the second substrate includes touch sensitive electrodes, and the drive circuit system further includes a touch sensitive circuit coupled with the touch sensitive electrodes and operates with the touch sensitive electrodes to detect touch operations on the touch display panel.

11. The touch display device according to claim 1, wherein the first substrate includes common electrodes, the common electrodes being applied an alternating voltage during the touch scanning period.

12. A drive method comprising:
selecting, at a touch display device, one of at least two gate lines as an initial scanning line; and
scanning, at the touch display device, the at least two gate lines from the initial scanning line to a last scanning line in sequence during each display scanning period, wherein for at least one block the initial scanning line of at least two display scanning periods are different.

13. The method according to claim 12, further comprising:
selecting, at the touch display device, different gate lines as the initial scanning line in at least two display scanning period for each block.

14. The method according to claim 12, further comprising:
selecting, at the touch display device, different gate lines as the initial scanning line in any two successive display scanning periods for at least one block.

15. The method according to claim 12, further comprising:
selecting, at the touch display device, different gate lines as the initial scanning line in any two successive display scanning periods for each block.

16. The method according to claim 12, wherein one of the at least two blocks, the initial scanning line is switched among the gate lines of the one of the at least two blocks in an order that is same with the order the gate lines are arranged.

17. The method according to claim 12, wherein for one of the at least two blocks, each gate line of the one of the at least two blocks is selected as the initial scanning line in an order that is contrary to the order the gate lines are arranged.

18. The method according to claim 12, wherein for one of the at least two blocks, each gate line of the one of the at least two blocks is selected as the initial scanning line in a random order.

19. The method according to claim 12, further comprising:
selecting, at the touch display device, different gate lines as the initial scanning line in display scanning periods of different frame.

20. The method according to claim 12, further comprising:
detecting, at the touch display device, touch operations applied on the touch display device during each touch scanning period.
